(19) United States
(12) Patent Application Publication
(10) Pub. No.: US 2025/0346707 A1
(43) Pub. Date: Nov. 13, 2025

(54) ADHESIVE FOR DERIVED WOOD PRODUCTS

(71) Applicants: Flooring Industries Limiated, SARL, Bertrange (LU); INSAREC BV, Zulte (BE)

(72) Inventors: Koen NEL, Kortrijk (BE); Geert COUDENYS, Lotenhulle (BE); Dirk STANSSENS, Houthalen (BE); Rudy GALLE, Gavere (BE); Hendrik DE KEUKELEIRE, Luxembourg (LU)

(21) Appl. No.: 18/040,361

(22) PCT Filed: Sep. 2, 2021
(86) PCT No.: PCT/IB2021/058011

§ 371 Date: Feb. 2, 2023

(30) Foreign Application Priority Data
Sep. 7, 2020 (BE) 2020/5615

(51) Int. Cl. C08G 18/38; B27N 3/00; C08G 18/76; C08L 97/02

(52) U.S. Cl. CPC C08G 18/3895; B27N 3/002; C08G 18/7671; C08L 97/02

(57) ABSTRACT

Emulsion of isocyanate in water. The isocyanate comprises one or more of a diisocyanate, a polyisocyanate, a derivative of a diisocyanate or a derivative of a polyisocyanate. The emulsion comprises water glass. The ratio in the emulsion of the weight of the combination of water and water glass on the one hand to the weight of the isocyanate on the other hand is preferably between 1.2 and 6.

### TECHNICAL FIELD

The invention relates to emulsions that are usable as glue in the production of derived wood products; as well as a method for producing emulsions of this kind. The invention further relates to derived wood products bonded with said glue, and methods for producing said derived wood products.

### PRIOR ART

In derived wood products glue is used for bonding wood particles, wood fibers, wood strands, layers of wood and/or other wooden parts or components to each other. Examples of these derived wood products are chipboards, wood fiber boards (such as MDF—Medium Density Fiberboard and HDF—High Density Fiberboard), OSB (Oriented Strand Board) boards, and multiplex boards.

It is also possible to glue cellulose fibers or cellulose products to form boards. Examples are bamboo, straw, hemp fibers or hemp strands, kenaf etc.

The commonest glue used in the production of derived wood products is an aminoplast polymer, produced by a polycondensation reaction from urea and formaldehyde to form a UF resin. Optionally melamine is added and a melamine urea formaldehyde resin (MUF resin) is obtained, or melamine and phenol are added (MUPF resins: melamine urea phenol formaldehyde). The great advantages of these glues are their low cost—owing to the use of inexpensive raw materials in their preparation—; and their high reactivity. In derived wood products, these glues may release formaldehyde during and after polymerization. Efforts are increasingly being made to limit the release of formaldehyde or even reduce it to zero. Therefore formaldehyde-free glues have been and are being sought for producing derived wood products.

US2006/0163769 describes the use of water glass as glue in the production of derived wood products that are fire-resistant.

A known formaldehyde-free glue for use in the production of derived wood products consists of polymeric methylene diphenyl diisocyanate (pMDI). These pMDI glues lead to derived wood products with high strength and good water resistance. However, these glues have a number of drawbacks. In the first place they are much more expensive than the traditionally used aminoplasts; this leads to a large increase in the cost of the derived wood products. On the other hand these glues have lower stability than the conventional aminoplasts, they have a strong tendency to adhere to processing equipment—this leads among other things to the need for frequent cleaning of processing equipment—and during application they may give rise to the release of isocyanate monomers. This has an adverse effect on the efficiency of the production process for the derived wood products.

The pMDI glues have better adhesiveness than the traditionally used aminoplasts. Therefore less glue is needed. However, this may be a disadvantage, because the smaller amount of glue may lead to an unsatisfactory distribution of the glue over the substrate.

U.S. Pat. No. 4,190,459A describes a process for producing mineral fiber mats for use as insulating material. The mineral fibers are bonded together by means of a glue, which is applied as a so-called emulsion of water glass and an isocyanate. In U.S. Pat. No. 4,190,459A it is recommended to use a water glass with a solids content by weight between 40 and 55%. The so-called emulsions stated in U.S. Pat. No. 4,190,459A have an initial viscosity of 10 000 mPa·s. However, this so-called emulsion is not stable, since the viscosity quickly increases over time. CA2019382A1 refers in its prior art section to U.S. Pat. No. 4,190,459A and states that the emulsions described in U.S. Pat. No. 4,190,459A have limited stability.

CA2019382A1 describes a mixture of isocyanate and a sufficient amount of metal soap to be used as glue in derived wood products. The metal soap is used as a blocking compound to prevent reaction between water and isocyanate, therefore a sufficient amount of metal soap is required. CA2019382A1 further describes that when mixing isocyanate and the sufficient amount of metal soap, water glass may also be mixed in to form an emulsion.

### DESCRIPTION OF THE INVENTION

One aim of the invention is to make an emulsion available that is free from formaldehyde and that can be used very easily as glue in the production of derived wood products such as chipboards, MDF panels, HDF panels, OSB panels, and multiplex boards.

A specific aim is to make a stable emulsion available that can be used as glue in the stated applications.

A specific aim of embodiments of the invention is to provide emulsions of this kind that can be used very easily as glue.

A specific aim is to obtain emulsions with low viscosity, so that good distribution of the emulsion over the wood-based substrates to be glued can be obtained.

The first aspect of the invention is an emulsion of isocyanate in water. The isocyanate comprises one or more of a diisocyanate, a polyisocyanate, a derivative of a diisocyanate or a derivative of a polyisocyanate. The emulsion comprises water glass. The ratio in the emulsion of on the one hand the weight of the combination of water and water glass to on the other hand the weight of the isocyanate is preferably between 1.2 and 6. More preferably this ratio is more than 1.5, more preferably this ratio is more than 1.8; and preferably this ratio is lower than 4; more preferably this ratio is lower than 3.5, and more preferably this ratio is lower than 3.2.

An important advantage of the invention is that a stable emulsion of isocyanate in water is obtained. The water glass then functions as an emulsifier; a shell of water glass is present around the isocyanate droplets in the emulsion. Water is the continuous phase in the emulsion. The emulsion has a low viscosity, which remains stable over time. The low viscosity means easier and more efficient application of the emulsion as glue, for example by spraying, in the production of derived wood products such as chipboards, MDF panels, HDF panels, OSB panels, and multiplex boards. Owing to the low viscosity, good distribution of the emulsion over wood-based materials to be glued can easily be obtained. Good distribution of the emulsion over wood-based materials to be glued is critical, on account of the rough surface and the porosity of wood-based materials such as wood chips, wood strands and wood fibers.

The so-called emulsions stated in U.S. Pat. No. 4,190,459A have an initial viscosity of 10 000 mPa·s. However, this emulsion is not stable, since the viscosity quickly increases over time. U.S. Pat. No. 4,190,459A relates to gluing of mineral fibers to fiber mats for insulation purposes. These fiber mats have a low density. Mineral fibers have a smooth surface, and not the porous and rough surface of the wood raw material that is used in the production of derived wood products. In view of the porosity of the wood raw material, a glue with low viscosity is desirable, for good penetration of the glue into the pores to ensure effective gluing.

The emulsion according to the invention may be produced some considerable time before use, and may be stored for a considerable time without loss of functionality. Surprisingly, it was found that with too high a ratio of the weight of the combination of water and water glass on the one hand to the weight of the isocyanate on the other hand, a less stable emulsion is obtained.

Since the viscosity of the emulsion of the first aspect of the invention is low, this emulsion can be applied easily, e.g. by spraying by means of spraying nozzles. The low viscosity is also advantageous to allow good penetration of the emulsion in pores of the raw material to be glued (e.g. wood chips, wood fibers or wood strands). This improves gluing.

To make the emulsion of the invention, it is essential to mix the ingredients with high turbulence. This was found to be necessary, probably because of the large difference between the viscosity of the combination of water and water glass on the one hand and the viscosity of the isocyanate on the other hand. If mixing is not done with high turbulence, a stable emulsion with low viscosity is not obtained; instead, the two components separate and an aqueous phase and an organic phase are obtained.

Using pure pMDI glue, 3 to 5 wt % pMDI relative to the wood mass to be glued (e.g. wood chips) is usually sufficient to obtain the required mechanical properties and water resistance of the board produced. With urea formaldehyde (UF) glues, the amount required is often more than 8 wt % relative to the wood mass to be glued. The disadvantage of the small amount of pMDI required often causes insufficiently homogeneous distribution of the glue over the surfaces of the wood mass to be glued. With the emulsion according to the invention, the volume is increased by adding water glass and water. As a result, a more uniform distribution of the glue can be obtained.

The emulsion of the invention has the additional advantage that the glue does not adhere to processing equipment. Therefore, the frequent cleaning that is the case with pure pMDI glue is not necessary. This is positive for process efficiency in the production of derived wood products.

Since the inexpensive water glass will also contribute to the gluing action, the amount of expensive isocyanate may remain limited. The amount of water glass is therefore preferably selected so that the water glass is not only active as an emulsifier, but also to an important extent as a gluing component. This makes it possible to use less isocyanate, and thus obtain a cheaper glue (and cheaper derived wood products produced with this glue), which can be metered well and uniformly distributed.

Water glass also ensures an improvement in the reactivity between hydroxyl groups of wood on the one hand and the isocyanate on the other hand. The water glass is thus not only active as an emulsifier for the isocyanate. During use of the glue and with increase in temperature and after evaporation of the water, the emulsion is broken and the water glass acts as a catalyst for the reaction of the isocyanate with the hydroxyl groups of wood.

It is clear that the emulsion according to the invention differs from the emulsions described in CA2019382A1. In CA2019382A1 the emulsion comprises a sufficient amount of metal soap relative to the amount of isocyanate to obtain blocking of the isocyanate. CA2019382A1 states that it is necessary to mix the metal soap with the isocyanate first, and only then add the water glass. CA2019382A1 describes that the amount of water glass may vary over a wide range. It is clear that in CA2019382A1 the metal soap is the emulsifier, and not the water glass. Thus, the emulsion in CA2019382A1 consists of isocyanate droplets surrounded by a shell of metal soap, in the aqueous phase. The water glass in CA2019382A1 appears to be added as an additional gluing agent, and not as an emulsifier.

In preferred embodiments of the first aspect of the invention, water forms the continuous phase in the emulsion.

Preferably the water glass forms a shell around the isocyanate droplets.

Preferably the isocyanate comprises, or consists of, a methylene diphenyl diisocyanate and/or a derivative of methylene diphenyl diisocyanate.

Preferably the isocyanate comprises, or consists of, a polymeric methylene diphenyl diisocyanate (pMDI).

In principle, various types of isocyanates may be used in the invention. However, pMDI is preferred. In contrast to many other isocyanates, pMDI has little or no compatibility with water. With many types of isocyanates, water reacts with the isocyanate groups, leading to the release of carbon dioxide. Since pMDI and water are not compatible with each other, there is only limited reaction when water and pMDI come into contact with each other. When water and pMDI are mixed, and mixing is stopped, the water and the pMDI separate from each other and only a limited reaction occurs between water and pMDI. The use of water glass in the emulsions of the first aspect of the invention is necessary in order to stabilize the emulsion.

In addition, pMDI has a large number of reactive groups. This is positive for the adhesiveness, since dense crosslinking is obtained. pMDI is also the cheapest choice of the commercially available isocyanates.

Owing to these aspects, pMDI allows optimal attainment of the advantages of emulsions according to the invention, with low cost of the glue and of the derived wood products produced.

Preferably, the amount of dry matter in the combination of the water and the water glass in the emulsion is between 5 and 30 wt %, and more preferably between 8 and 25 wt %. Emulsions according to this embodiment display even better properties relating to stability of the viscosity. Both the lower limit and the upper limit for the amount of dry matter in the combination of the water and the water glass in the emulsion are important for this. The amount of water in this embodiment not only ensures low viscosity, but also and especially better phase separation between the continuous aqueous phase and the organic phase, and thus a more stable emulsion. Surprisingly, it was found that a lower amount of dry matter in the combination of the water and the water glass in the emulsion was a disadvantage for obtaining a stable emulsion. With excess water, it is found that, in percentage terms, the water glass remains more in the aqueous phase and less in the interphase between water and isocyanate, so that the emulsion is less stable. There is thus an optimum for the amount of dry matter in the combination of water and water glass, with regard to the stability of the emulsion.

Water glass per se usually has a solids content between 35 and 45 wt %, depending on its composition. However, for emulsions according to the invention, preferably extra water should be added, so that the amount of dry matter in the combination of the water and the water glass in the emulsion is preferably between 5 and 30 wt %, and more preferably between 8 and 25 wt %.

Preferably the ratio of the weight of isocyanate solid matter relative to the weight of water glass solid matter in the emulsion is higher than 0.5, and more preferably higher than 1, and more preferably higher than 1.5, and even more preferably higher than 2, and preferably lower than 5, more preferably lower than 4. Such embodiments are preferred since they ensure sufficient water resistance for derived wood products that are glued with emulsions of this kind.

Preferably the water glass has a molar ratio of SiO₂ relative to X₂O between 1.5 and 3, more preferably between 1.7 and 2.6, and even more preferably between 1.8 and 2.3; where X is selected from one or more of Li, Na or K. Water glass is a reaction product of SiO₂ and XOH in water, where X is selected from one or more of Li, Na or K. The use of Na₂O in the water glass is preferred, on account of the ready availability of this kind of water glass. The properties of the water glass vary depending on the ratio of the raw materials (SiO₂ and XOH). The composition of water glass is given as the molar ratio of its constituent components, expressed as SiO₂ and Na₂O. Surprisingly, the molar ratio was found to be crucial for obtaining a stable emulsion, and certainly when using pMDI as isocyanate. The use of water glass with too high a molar ratio SiO₂:Na₂O was found to lead to an unstable emulsion: the isocyanate droplets coagulate; this caused phase separation of the isocyanate (e.g. pMDI). At a molar ratio SiO₂:Na₂O that is too low, reaction was observed between the isocyanate on the one hand and the water and the water glass on the other hand. Gas bubbles were observed, indicating formation of CO2. The viscosity rose quickly, and a gel—and not an emulsion—was obtained.

Preferably, in the emulsion the weight ratio of the isocyanate relative to the water is between 1:1 and 1:5, and more preferably between 1:1 and 1:3. “Water” means the total amount of water, i.e. the water added as water plus the water in the water glass.

Preferably the emulsion comprises one or more water glass reactive components. The use of water glass reactive components facilitates emulsification and leads to even better stability of the emulsion. “Water glass reactive components” means components that can enter into a chemical reaction with water glass. Examples of water glass reactive components that may be used are silica (SiO₂), quartz, fly ash, silicate, aluminosilicate (such as clay) or meta-kaolin. Various kinds of clay may be used, such as kaolin, bentonite, or montmorillonite. Meta-kaolin is especially interesting, since it reacts with water glass during crosslinking, wherein a so-called geopolymer is formed. Since these water glass reactive components participate in network formation during gluing, the emulsion may contain less isocyanate (for example pMDI) for identical strength of the glued joint. This lowers the cost of the glue and of the derived wood products that are made using it.

More preferably, the emulsion comprises water glass reactive components in an amount between 5 and 100 wt % of the dry weight of the water glass, more preferably between 5 and 50 wt % of the dry weight of the water glass; even more preferably between 5 and 20 wt % of the dry weight of the water glass; even more preferably lower than 10 wt % of the dry weight of the water glass.

The emulsion may optionally comprise one or more of SiO₂, quartz, fly ash, silicate, an aluminosilicate or meta-kaolin.

The emulsion may comprise a soap and/or a silicone. Although the emulsions of the first aspect of the invention do not, owing to their stability, display any affinity for the processing equipment, and so do not adhere thereto, it may be useful to add additives to the emulsion that further prevent the glue adhering to processing equipment. Such additives may for example be soaps and/or silicone.

The emulsion may optionally comprise one or more of water-repellent additives, catalysts, dyes, pigments, flame retardants, cold-adhesion improvers, or blowing agents. The emulsion may comprise such additives in order to give the derived wood products specific properties and/or to improve the processability of the glue. Examples of water-repellent agents that may be used are wax emulsions (for example based on paraffin or hydrogenated vegetable oils), alkene-ketene dimers, and alkyl succinic acid anhydride. Preferably these water-repellent agents are added as emulsion. Examples of catalysts for accelerating and improving the reaction between the hydroxyl groups of wood and the isocyanate (e.g. pMDI) are tertiary amines and derivatives of tin; these products are well known in the polyurethane industry.

Preferably the viscosity of the emulsion at 25° C. is lower than 500 mPa·s, more preferably lower than 300 mPa·s, more preferably lower than 200 mPa·s.

Preferably the viscosity of the emulsion measured at 25° C. and after a waiting time of 30 minutes at 25° C. is lower than 1000 mPa·s, more preferably lower than 500 mPa·s, even more preferably lower than 200 mPa·s.

In preferred embodiments of the invention the emulsion comprises a thickener and the emulsion has a viscosity at 25° C. that is higher than 1000 mPa·s, and preferably is higher than 2000 mPa·s. The thickener is preferably selected from carboxymethylcellulose, starch, gum, associative thickeners or thickeners based on inverse emulsions. Emulsions according to said embodiments may be used in applications where glue with a relatively high viscosity is desired. This may be the case for example in the production of multiplex boards, where linecoaters may be used.

The second aspect of the invention is a derived wood product, wherein the product comprises particles, fibers, layers, strands or components of wood, and wherein the particles, fibers, strands, layers or components of wood have been glued to each other by means of an emulsion as in any embodiment of the first aspect of the invention. The emulsion may be added to the wood substrate in various ways. The emulsion may for example be sprayed into a rotating mixer containing the wood material, or sprayed onto a conveyor belt that is transporting the wood material. It is also possible to spray the emulsion into a pipeline conveying wood material, e.g. wood fibers, as is usual in the production of MDF and HDF products. If the wood material is coarser, for example in the case of layers of wood such as veneer, the emulsion may be applied by spraying, with a roller, or by immersing the wood material in the emulsion.

The third aspect of the invention is a derived wood product, wherein the derived product comprises particles, fibers, strands, layers or components of wood, and wherein the particles, fibers, strands, layers or components of wood are glued to each other with a glue. Optionally the derived wood product is a derived wood product as in any embodiment of the second aspect of the invention. The glue comprises isocyanate and water glass. The isocyanate comprises one or more of a diisocyanate, a polyisocyanate, a derivative of a diisocyanate, or a derivative of a polyisocyanate, wherein the sum of the dry weight of isocyanate and dry water glass is between 2 and 15 wt % of the assembled product, more preferably between 2 and 8 wt % of the assembled product and even more preferably between 2 and 5 wt % of the assembled product.

In a preferred embodiment of the third aspect of the invention the isocyanate comprises, or consists of, a methylene diphenyl diisocyanate and/or a derivative of methylene diphenyl diisocyanate.

In a preferred embodiment of the third aspect of the invention the isocyanate comprises, or consists of, a polymeric methylene diphenyl diisocyanate (pMDI).

In a preferred embodiment of the third aspect of the invention the water glass has a molar ratio of SiO₂ relative to X₂O between 1.5 and 3, more preferably between 1.7 and 2.6, and even more preferably between 1.8 and 2.3; where X is selected from one or more of Li, Na or K. The use of Na₂O is preferred since this is the most readily available.

In a preferred embodiment of the third aspect of the invention the glue comprises one or more of SiO₂, quartz, fly ash, silicate, an aluminosilicate or meta-kaolin.

Preferably, the derived wood product as in any embodiment of the second aspect or of the third aspect of the invention comprises wood, for example wood fibers, wood chips, wood strands or layers of wood. The required amount of emulsion depends on the wood material that is to be glued. If the specific surface area of the wood material is higher, a larger amount of glue must be used. As an example, for making chipboard, between 2 and 5 wt % of dry weight of emulsion is necessary relative to the weight of chips. It is an advantage that the amount of glue dry matter is significantly lower than when using aminoplast glue, for example such as the conventional urea formaldehyde emulsions.

Preferably, the derived wood product of the second aspect or of the third aspect of the invention is selected from an MDF board, an HDF board, a chipboard, an OSB board or a multiplex board.

A fourth aspect of the invention is a derived wood product—preferably a derived wood product as in any embodiment of the second aspect or of the third aspect of the invention—, wherein the derived wood product comprises a first layer, a second layer and a third layer, wherein the second layer is located between—and preferably in contact with—the first layer and the third layer, wherein each of the first layer, the second layer and the third layer comprises wood raw material. Preferably the first layer and the third layer comprise finer wood raw material than the second layer. The second layer is glued with a glue that comprises water glass and an isocyanate (preferably pMDI)—preferably a glue that is an emulsion as in any embodiment of the first aspect of the invention. The glue in the first layer and in the third layer is an aminoplast, for example a urea formaldehyde glue. Such products can be pressed in a single hot pressing operation. Such products have the advantage that release of formaldehyde is limited, while the sandwich construction gives very good mechanical properties. The use of finer wood material in the first and third layer, which preferably form the outermost layers of the derived wood product, provides a flatter surface of the derived wood product. Chipboards are examples of said derived wood products that may be produced with said layers: the first and the third layers (which form the outermost layers) comprise finer chips than the second layer. “Finer chips” and “finer wood material” means the average by weight of the wood raw material.

Preferably the combination of the first layer and the third layer makes up between 20 and 50 wt % of the total derived wood product. Preferably the second layer makes up between 50 and 80 wt % of the total derived wood product.

The fifth aspect of the invention is a method for making a derived wood product—preferably a derived wood product as in any embodiment of the second aspect, third aspect or fourth aspect of the invention—, wherein the method comprises the steps of
supplying particles, fibers, strands, layers or components of wood;
gluing—for example by spraying, dipping or by means of a roller—of these particles, fibers, strands, layers or components with an emulsion as in any embodiment of the first aspect of the invention; and
compressing the glued particles, fibers, strands, layers or components; and
crosslinking the glue at increased temperature and under pressure.

The glued wood substrates are heated and pressed in order to crosslink the glue and obtain a derived wood product with the desired density. The process conditions also depend on the wood raw material and the desired derived wood product. A person skilled in the art can determine suitable process conditions by means of routine experiments. During crosslinking, the water glass will act as catalyst for crosslinking the isocyanate from the emulsion.

Preferably, in this method, wood fibers, wood chips, wood strands or layers of wood are supplied, and a derived wood product is manufactured, selected from an MDF board, an HDF board, a chipboard, an OSB board or a multiplex board.

In one embodiment of the fifth aspect of the invention, the gluing of the particles, fibers, strands, layers or components with the emulsion is carried out more than 30 minutes after preparing the emulsion. This makes it possible to have a buffer of emulsion for interruptions in production or irregularities in production.

The sixth aspect of the invention is a method for producing an emulsion as in any embodiment of the first aspect of the invention, wherein the isocyanate, the water glass and the water are mixed with high turbulence in a mixing device, wherein an emulsion is formed with viscosity at 25° C. lower than 500 mPa·s, preferably lower than 300 mPa·s, and more preferably lower than 200 mPa·s. As already stated, it is necessary to mix with high turbulence in order to obtain the stable emulsion with low viscosity of the first aspect of the invention. The high turbulence leads to the necessary separation of the two phases, the fine distribution of the isocyanate (preferably pMDI) droplets and formation of a shell of water glass around these small isocyanate droplets, necessary for obtaining the stable emulsion with low viscosity.

The order of adding the various components may be changed, especially when using pMDI as isocyanate. Water glass and water may be added to pMDI separately. What is important is that the relative proportions of the various components are respected.

Preferably the mixing device comprises a homogenizer, a rotor-stator mixer, a high-shear mixer, an ultrasonic mixer or an in-line static mixer. These mixing devices are suitable for achieving the high turbulence that is necessary for making the stable emulsion with low viscosity. Preferably the two phases are mixed and the emulsion is formed just before it is to be used as glue. However, to compensate for interruptions or irregularities in production, sufficient stability of the emulsion is necessary.

Preferably first the water glass and the water are mixed, and then the isocyanate is added and is mixed in with high turbulence.

Preferably the water, the water glass and the isocyanate are each added separately to the mixing device.

Besides application for or in derived wood products, the various aspects of the invention—in the different embodiments described—may also be applied for producing derived products from other cellulose material than wood material. Examples of cellulose material that may be used in said derived cellulose products are cellulose fibers or cellulose products. Examples are bamboo, straw, flax shives, hemp fibers or hemp strands, and kenaf. Boards are examples of these derived cellulose products that can be made with or according to the various aspects of the invention with said cellulose material.

### EMBODIMENTS AND EXAMPLES

In a first example of the invention, 200 g pMDI, 200 g water glass with molar ratio SiO₂:Na₂O of 2.0 and with a solids content of 42%; and 200 g water were mixed in a high-shear mixer for 30 seconds. The result was a stable emulsion with viscosity (measured at 25° C.) of 120 mPa·s. After 30 minutes the emulsion was always still stable and the viscosity (measured at 25° C.) was always still 120 mPa·s.

In a second example of the invention, 200 g pMDI, 200 g water glass with molar ratio SiO₂:Na₂O of 1.8 and with a solids content of 42%; and 250 g water were mixed in a high-shear mixer for 30 seconds. A stable emulsion with viscosity (at 25° C.) of 120 mPa·s was obtained. After 30 minutes the viscosity (measured at 25° C.) was always still 120 mPa·s; after 60 minutes the viscosity (measured at 25° C.) was 140 mPa·s.

In a third example of the invention, 200 g pMDI, 100 g water glass with molar ratio SiO₂:Na₂O of 2.0 and with a solids content of 42%; and 300 g water were mixed in a high-shear mixer for 30 seconds. A stable emulsion with viscosity (at 25° C.) of 100 mPa·s was obtained. After 30 minutes the viscosity (measured at 25° C.) was 120 mPa·s.

In comparative example four, 300 g pMDI, 280 g water glass with molar ratio SiO₂:Na₂O of 2.0 and with a solids content of 42% were mixed in a high-shear mixer for 30 seconds. An emulsion with viscosity (at 25° C.) of 2400 mPa·s was obtained. After 15 minutes the viscosity had increased to above 20000 mPa·s and the temperature of the emulsion had risen from 25° C. to 40° C. The inventors suspect that the amount of water was insufficient and a stable emulsion with low viscosity was not obtained.

In a fifth example, 200 g pMDI, 200 g water glass with molar ratio SiO₂:Na₂O of 2.8 and with a solids content of 35%; and 200 g water were mixed in a high-shear mixer for 30 seconds. A with viscosity (at 25° C.) of 100 mPa·s was obtained. After five minutes, some pMDI was released from the emulsion. This emulsion may admittedly be used as glue, but only directly after preparation of the emulsion.

In comparative example six, 200 g pMDI, 200 g water glass with molar ratio SiO₂:Na₂O of 1.4 and with a solids content of 43% were mixed in a high-shear mixer for 30 seconds. An emulsion with viscosity (at 25° C.) of 120 mPa·s was obtained. After 20 minutes the temperature of the emulsion had risen from 25° C. to 35° C. This indicates a chemical reaction of the pMDI with water. The emulsion thus lacks stability.

In a seventh example, 200 g pMDI, 200 g water glass with molar ratio SiO₂:Na₂O of 2.0 and with a solids content of 42%, 300 g water; and 30 g meta-kaolin were mixed in a high-shear mixer for 30 seconds. A stable emulsion with viscosity (at 25° C.) of 140 mPa·s was obtained. After 60 minutes the viscosity (measured at 25° C.) was 180 mPa·s.

Example eight relates to the production of a chipboard. 80 g water was added to 1000 g of dried wood chips. During thorough mixing of these chips, 60 g of the emulsion of the first example was sprayed onto these chips. These glued chips were held at 25° C. for 15 minutes, after which they were pressed in a heated press to a panel with a thickness of 12 mm and a density of 680 kg/m³. The panel had excellent mechanical properties. The elastic modulus was 2200 N/mm², the transverse tensile strength was 0.61 N/mm², and the bending strength was 11.2 N/mm².

Comparative example nine relates to a chipboard. Example 8 was repeated, but this time the water glass 2.0 (=molar ratio SiO₂:Na₂O equal to 2.0) in the emulsion of the first example was replaced with water glass 3.2 (=molar ratio SiO₂:Na₂O equal to 3.2) with 42% solids content. The emulsion had limited stability. Therefore, it was sprayed on the chips directly after mixing pMDI, water glass and water. The chips thus glued were then pressed to a chipboard in the same way as in example eight. This chipboard had poor mechanical properties. The transverse tensile strength was less than 0.1 N/mm². This example shows the importance of using the correct types of water glass to obtain derived wood products with suitable mechanical properties.

1. An emulsion of isocyanate in water, wherein water forms the continuous phase in the emulsion,
wherein the isocyanate comprises one or more of a diisocyanate, a polyisocyanate, a derivative of a diisocyanate or a derivative of a polyisocyanate,
wherein the emulsion comprises water glass, and
wherein in the emulsion, the ratio of the weight of the combination of water and water glass to the weight of the isocyanate is between 1.2 and 6.

2-3. (canceled)

4. The emulsion of claim 1, wherein the isocyanate comprises or consists of a methylene diphenyl diisocyanate, a polymeric methylene diphenyl diisocyanate (pMDI) or a derivative of methylene diphenyl diisocyanate; or combinations thereof.

5. (canceled)

6. The emulsion of claim 1, wherein the amount of dry matter in the combination of the water and the water glass in the emulsion is between 5 and 30 wt %.

7. The emulsion of claim 1, wherein the weight ratio of the isocyanate solid matter relative to the water glass solid matter is higher than 0.5 and lower than 5.

8. The emulsion of claim 1, wherein the water glass has a molar ratio of SiO₂ relative to X₂O between 1.5 and 3,
wherein X is selected from one or more of Li, Na or K.

9. The emulsion of claim 1, wherein in the emulsion the weight ratio of the isocyanate relative to the water is between 1:1 and 1:5.

10-14. (canceled)

15. The emulsion of claim 1, wherein the viscosity of the emulsion at 25° C. is lower than 500 mPa·s.

16. The emulsion of claim 1, wherein the viscosity of the emulsion measured at 25° C. and after a waiting time of 30 minutes at 25° C. is lower than 1000 mPa·s.

17-18. (canceled)

19. A derived wood product, wherein the derived product comprises particles, fibers, strands, layers or components of wood, and wherein the particles, fibers, strands, layers or components of wood are glued to each other with a glue, wherein the glue comprises isocyanate and water glass, wherein the isocyanate comprises one or more of a diisocyanate, a polyisocyanate, a derivative of a diisocyanate, or derivative of a polyisocyanate, wherein the sum of the dry weight of isocyanate and dry water glass is between 2 and 15 wt % of the assembled product.

20. The derived wood product in accordance with claim 19, wherein the isocyanate comprises or consists of a methylene diphenyl diisocyanate or a derivative of methylene diphenyl diisocyanate, or combinations thereof.

21. The derived wood product as in claim 19, wherein the isocyanate comprises or consists of a polymeric methylene diphenyl diisocyanate (pMDI).

22. The derived wood product in accordance with claim 19, wherein the water glass has a molar ratio SiO₂ relative to X₂O between 1.5 and 3 wherein X is selected from one or more of Li, Na or K.

23. The derived wood product in accordance with claim 19, wherein the glue comprises one or more of SiO₂, quartz, fly ash, silicate, an aluminosilicate or meta-kaolin.

24. The derived wood product in accordance with claim 19, wherein the derived wood product comprises wood selected from wood fibers, wood chips, wood strands, layers of wood; or combinations thereof.

25. The derived wood product in accordance with claim 19, wherein the derived wood product is selected from an MDF board, an HDF board, a chipboard, an OSB board or a multiplex board.

26-28. (canceled)

29. A method for producing an emulsion of isocyanate in water, wherein water forms the continuous phase in the emulsion,
wherein the isocyanate comprises one or more of a diisocyanate, a polyisocyanate, a derivative of a diisocyanate or a derivative of a polyisocyanate,
wherein the emulsion comprises water glass,
wherein in the emulsion, the ratio of the weight of the combination of water and water glass to the weight of the isocyanate is between 1.2 and 6;
wherein the method comprises the step of mixing the isocyanate, the water glass and the water with high turbulence in a mixing device, wherein an emulsion is formed with viscosity at 25° C. lower than 500 mPa·s.

30. (canceled)

31. The method in accordance with claim 29, wherein first the water glass and the water are mixed, and then the isocyanate is added and mixed-in with high turbulence.

32. (canceled)
